(19) United States
(12) Patent Application Publication
(10) Pub. No.: US 2017/0053444 A1
(43) Pub. Date: Feb. 23, 2017

(54) AUGMENTED REALITY INTERACTIVE SYSTEM AND DYNAMIC INFORMATION INTERACTIVE DISPLAY METHOD THEREOF

(71) Applicant: National Taipei University of Technology, Taipei (TW)

(72) Inventors: Shih-Chia Huang, Taipei (TW); Bo-Hao Chen, Taipei (TW); Sheng-Kai Chou, Taipei (TW); Jenq-Neng Hwang, Bellevue, WA (US)

(21) Appl. No.: 14/864,789

(22) Filed: Sep. 24, 2015

(30) Foreign Application Priority Data
Aug. 19, 2015 (TW) 104127060

(51) Int. Cl. G06T 19/00; B60K 35/00; G06F 3/0484; G06F 3/01; G06F 3/0482

(52) U.S. Cl. CPC G06T 19/006; G06F 3/011; G06F 3/0482; G06F 3/04847; B60K 35/00; B60K 2350/1072; B60K 2350/1052; B60K 2350/1044; B60K 2350/1096

(57) ABSTRACT

An augmented reality interactive system and a dynamic information interactive display method thereof are provided. The augmented reality interactive system suitable for being disposed in a transportation vehicle includes a transparent display, a motion detection unit, and a processing unit. The transparent display has a display panel pervious to light. The display panel is suitable for serving as a windshield of the vehicle, where the transparent display controls the image displayed by the display panel according to a display signal, so as to display an interactive information on the display panel. The motion detection unit detects an operation motion of a driver, so as to generate a control command. The processing unit coupled to the transparent display and the motion detection unit receives the control command, so as to generate the corresponding display signal based on the operation motion for controlling the operation of the transparent display.

### CROSS-REFERENCE TO RELATED APPLICATION

This application claims the priority benefit of Taiwan application serial no. 104127060, filed on Aug. 19, 2015. The entirety of the above-mentioned patent application is hereby incorporated by reference herein and made a part of this specification.

### BACKGROUND OF THE INVENTION

Field of the Invention

The invention relates to a system and a control method thereof, and particularly relates to an augmented reality interactive system and a dynamic information interactive display method thereof.

Description of Related Art

Along with development of technology, and an increasingly affluent life, transportation vehicles are increasingly popular in general families. However, along with increasingly frequent use of the transportation vehicles (for example, cars, ships, airplanes, etc.), consequent traffic accidents are also significantly increased. Taking a vehicle as an example, in order to improve vehicle driving safety, a head-up display (HUD) system has become a basic equipment of many vehicles. The HUD system may project driving information such as a vehicle speed, a fuel capacity, a mileage and distances with front and rear vehicles, etc., onto a front windshield of the vehicle, such that the driver may simultaneously observe the driving information projected on the front windshield of the vehicle while paying attention to road conditions through the front windshield. Therefore, the driver is avoided to be distracted to look down to watch a car dashboard during a driving process, so as to avoid a traffic accident.

However, in order to install the HUD system in a limited space of the vehicle, the HUD system generally has a miniaturization design, such that the HUD system can be limited and fixed within a small region to project and display an image. Therefore, in the driver's point of view, the information displayed by the general HUD system cannot directly indicate scenes and objects on the driving direction or information between the vehicles, so that the driver is still hard to intuitively determine an actual road condition according to the projected display information.

Moreover, regarding an application of a general HUD system, the driver may adjust a setting and a function of the HUD system only through a manner of manually controlling a computer input interface. In other words, the driver is hard to directly control the HUD system during the period of driving the vehicle, which limits an application range of the HUD system.

### SUMMARY OF THE INVENTION

The invention is directed to an augmented reality interactive system and a dynamic information interactive display method thereof, which are capable of resolving the problem mentioned in the related art.

The invention provides an augmented reality interactive system, which is adapted to be disposed in a transportation vehicle, and the augmented reality interactive system includes a transparent display, a motion detection unit, and a processing unit. The transparent display has a display panel pervious to light. The display panel is adapted to serve as a windshield of the transportation vehicle, where the transparent display controls an image displayed on the display panel according to a display signal, so as to display interactive information on the display panel. The motion detection unit is configured to detect an operation motion of a user, so as to generate a control command. The processing unit is coupled to the transparent display and the motion detection unit, and is configured to receive the control command, so as to generate the corresponding display signal based on the operation motion for controlling an operation of the transparent display.

The invention provides a dynamic information interactive display method applied to a transportation vehicle, which includes following steps. Interactive information is displayed through a display panel pervious to light, where the display panel is adapted to serve as a windshield of the transportation vehicle, and an image displayed on the display panel is controlled by a display signal. An operation motion of a user is detected through a motion detection unit, so as to generate a control command. The control command is received through a processing unit, so as to generate the corresponding display signal based on the operation motion for controlling the display panel.

The invention provides an augmented reality interactive system, which is adapted to be disposed in a transportation vehicle, and the augmented reality interactive system includes a transparent substrate, a motion detection unit, and a processing unit. The transparent substrate is pervious to light and has a display function, where the transparent substrate is adapted to serve as a windshield of the transportation vehicle. The motion detection unit is configured to detect an operation motion, so as to generate a control command. The processing unit is coupled to the transparent substrate and the motion detection unit, and is configured to receive the control command, so as to control an operation of the transparent substrate based on the operation motion.

According to the above descriptions, the embodiments of the invention provides an augmented reality interactive system and a dynamic information interactive display method thereof, by which the interactive information can be displayed on the windshield, and the interactive information can be integrated with scenes and objects in front of the transportation vehicle to form an augmented reality image under a premise that the driver does not look down. In collaboration with extensible application programs, the driver is able to perform an interactive operation with the augmented reality image, so as to obtain more complete driving information and driving assistance to improve driving safety and operability.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a functional block diagram of an augmented reality interactive system according to an embodiment of the invention.

FIG. 2 is a schematic diagram of a physical configuration of the augmented reality interactive system according to an embodiment of the invention.

FIG. 3 is a flowchart illustrating a dynamic information interactive display method applied to a transportation vehicle according to an embodiment of the invention.

FIG. 4 is a schematic diagram of an interactive information of the augmented reality interactive system according to an embodiment of the invention.

FIG. 5 is a schematic diagram of a driving perspective of a transportation vehicle applying the augmented reality interactive system according to an embodiment of the invention.

FIG. 6 to FIG. 9 are operational schematic diagrams of the augmented reality interactive system according to different embodiments of the invention.

### DESCRIPTION OF EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

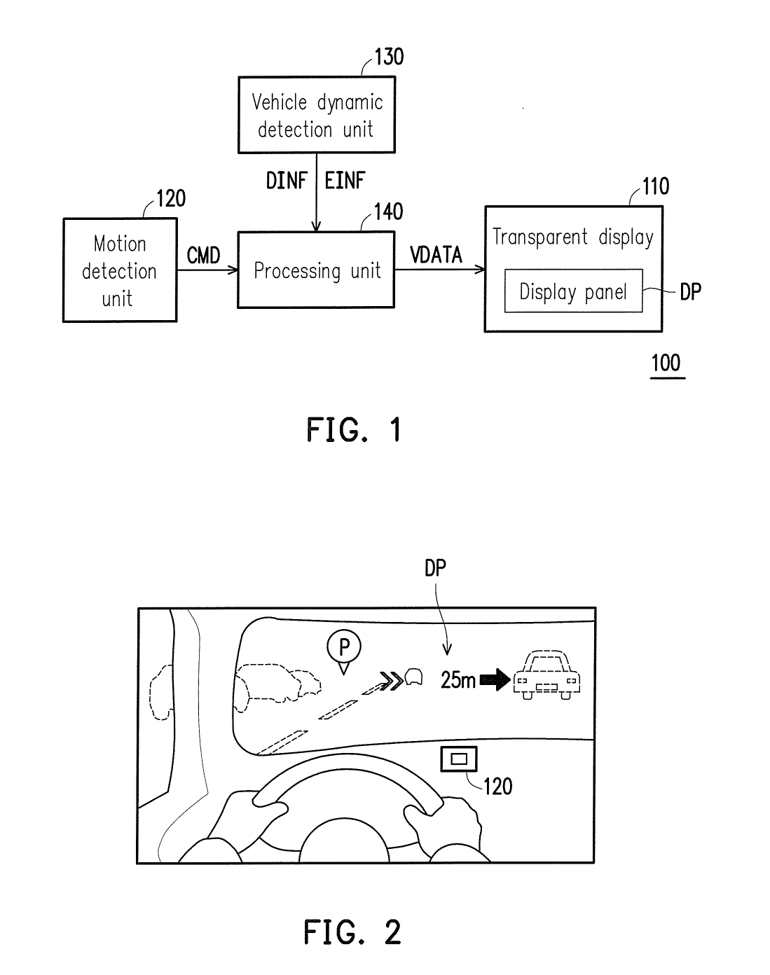

FIG. 1 is a functional block diagram of an augmented reality interactive system according to an embodiment of the invention. FIG. 2 is a schematic diagram of a physical configuration of the augmented reality interactive system according to an embodiment of the invention. Referring to FIG. 1 and FIG. 2, the augmented reality interactive system 100 of the present embodiment is adapted to be disposed in a general transportation vehicle (for example, a car, a ship, an airplane, etc.), and includes a transparent display 110, a motion detection unit 120, a vehicle dynamic detection unit 130 and a processing unit 140.

The transparent display 110 has a display panel DP pervious to light and a driving portion (not shown) used for driving the display panel DP, where the display panel DP pervious to light is disposed in the transportation vehicle to serve as a windshield of the transportation vehicle, as shown in FIG. 2 (in order to distinguish physical scenes and objects with an image displayed on the display panel DP, the physical scenes and objects are all illustrated by dash lines, and the image on the display panel DP is illustrated by solid lines). The driving portion of the transparent display 110 is, for example, composed of a timing controller, a gate driver and a source driver, etc., which is used for controlling the image displayed by the display panel DP.

In the present embodiment, the display panel DP is, for example, a side light-incident type liquid crystal display (LCD) panel driving according to a field-sequential-color method, a self-luminous active matrix organic light-emitting diode (AMOLED) panel made of a transparent material, an electrowetting display panel adopting a transparent ink and a hydrophobic layer material, or any type of a transparent substrate, which is not limited by the invention. In other words, as long as a driver can observe objects at one side of the display panel DP from another side of the display panel DP (i.e. the display panel DP is pervious to light), and the display panel DP has an image display function, the display structure thereof is considered to be complied with the transparent display 110 of the invention.

It should be noted that although in the embodiment of FIG. 2, the display panel DP is taken as the front windshield, in other embodiments, the display panel DP can also be applied to a side window, a skylight or a rear windshield, which is not limited by the invention. In other words, the “windshield” defined in the present invention is not limited to the front windshield, but any object that is pervious to light in the transportation vehicle can be implemented by the display panel DP of the invention.

The motion detection unit 120 is configured to detect an operation motion of the driver, and generates a corresponding control command CMD according to the operation motion. The operation motion can be at least one of a gesture motion, a voice control motion, an eye control motion and a brain wave control motion according to a design requirement. A hardware configuration of the motion detection unit 120 can be designed according to the selected operation type. For example, if the operation motion is a gesture motion or an eye control motion, the motion detection unit 120 is, for example, implemented by an image capturing device and a corresponding image processing circuit; if the operation motion is a voice control operation, the motion detection unit 120 is, for example, implemented by an audio capturing device and a corresponding audio processing circuit; and if the operation motion is a brain wave control motion, the motion detection unit 120 is, for example, implemented by a brain wave detection device and a corresponding signal processing circuit. Moreover, the motion detection unit 120 can be disposed near a driver seat (for example, disposed on a dashboard as shown in FIG. 2, though the invention is not limited thereto) of the transportation vehicle in hardware configuration, so as to capture the operation motion of the driver.

The vehicle dynamic detection unit 130 is configured to detect driving information DINF (for example, a vehicle speed, a driving path offset or a steering wheel turning direction, etc.) of the transportation vehicle and environment information EINF (a position and a distance of an obstacle on a driving direction, an environment light intensity and an environment temperature, etc.) around the transportation vehicle, and provides the detected driving information DINF and the environment information EINF to the processing unit 140. In the present embodiment, the actual hardware of the vehicle dynamic detection unit 130 can be correspondingly set according to a type of the required driving information DINF and the environment information EINF. For example, if the driving information DINF includes the vehicle speed, the vehicle offset and the steering wheel turning direction, the hardware of the vehicle dynamic detection unit 130 may include a vehicle computer originally installed on the transpiration vehicle. If the environment information EINF includes the position and the distance of the obstacle on the driving direction, the environment light intensity and the environment temperature, the hardware of the vehicle dynamic detection unit 130 may include an object sensor (for example, an infrared sensor, an ultrasonic sensor, etc.), a light sensor and a temperature sensor, which is determined according to an actual design requirement of a designer, and is not limited by the invention.

The processing unit 140 is a control core of the whole augmented reality interactive system 100, which is configured to control an operation of each unit in the augmented reality interactive system 100, and perform signal processing according the control command CMD, the driving information DINF and the environment information EINF received from each of the units, so as to generate a corresponding display signal VDATA to control an operation of the transparent display 110. The processing unit 140 may implement an interactive control between the driver and the image displayed by the display panel DP according to the control command CMD, and may perform a computation processing of an application program according to the driving information DINF and the environment information EINF, or make the display panel DP to display auxiliary information related to the driving information DINF and the environment information EINF.

In an exemplary embodiment of the invention, the hardware configuration of the processing unit 140 can be implemented by a processor of the vehicle computer originally install on the transportation vehicle, and the function of performing the signal processing according to the control command CMD, the driving information DINF and the environment information EINF to generate the corresponding display signal VDATA can be implemented by software. In another exemplary embodiment, the processing unit 140 can also be implemented by independent hardware, which is not limited by the invention.

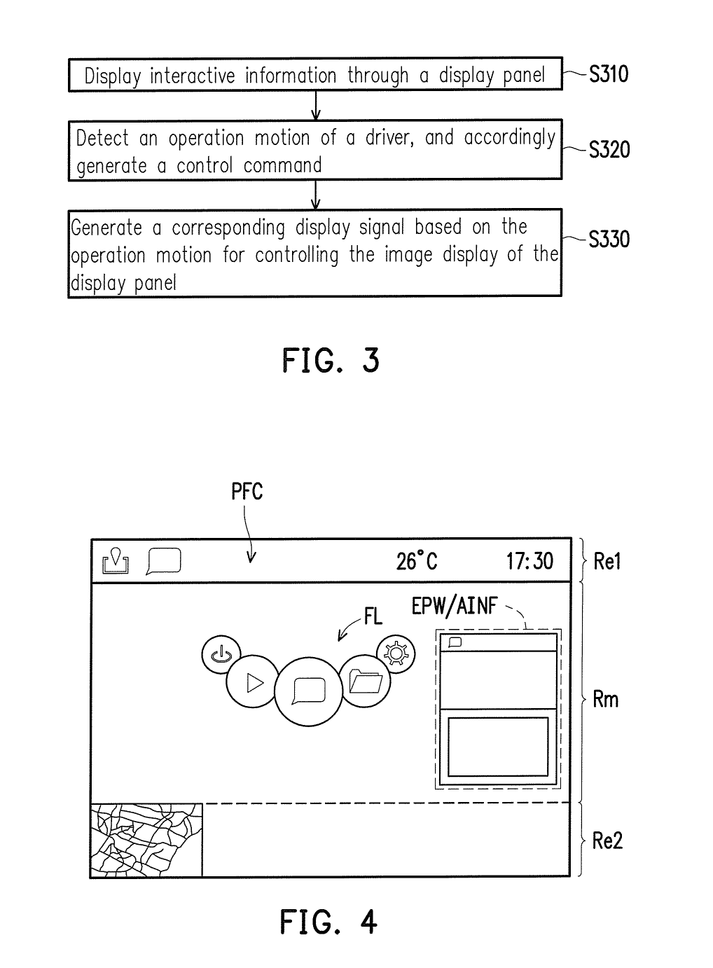

FIG. 3 is a flowchart illustrating a dynamic information interactive display method applied to the transportation vehicle according to an embodiment of the invention. Referring to FIG. 1 to FIG. 3, in the dynamic information interactive display method, first, a driving portion receives the display signal VDATA provided by the processing unit 140, so as to drive the display panel DP serving as the windshield, such that the display panel DP display interactive information (step S310).

Then, the motion detection unit 120 detects an operation motion of the driver, and accordingly generates the control command CMD (step 320). To be specific, in the step S320, after the motion detection unit 120 detects the operation motion of the driver, the motion detection unit 120 determines whether the detected operation motion is complied with a predetermined command motion, and if yes, the motion detection unit 120 generates the corresponding control command CMD; and if not, the motion detection unit 120 continually detects the operation motion of the driver.

Then, the processing unit 140 receives the control command CMD generated by the motion detection unit 120, and generates the corresponding display signal VDATA based on the operation motion of the driver, so as to control the image display of the display panel DP (step S330).

In detail, under the system structure of the augmented reality interactive system 100, information can be displayed on the windshield of the transportation vehicle, so as to integrate scenes and objects in the front of the transportation vehicle to implement a display application of augmented reality. In collaboration with different types of application programs, for example, GPS navigation, reverse display, a driving visual enhancement technology, etc., an interactive control between the driver and an augmented reality image (i.e. the interactive information combined with the scenes and objects in front of the transportation vehicle) can be implemented based on a somatosensory control manner. Therefore, under the system structure of the invention, a plurality of interactive functions facilitating vehicle driving can be extended.

For example, the interactive information can be designed as interactive information IMG shown in FIG. 4. Referring to FIG. 4, in the present embodiment, the interactive information IMG includes a permanent function column PFC, and according to the operations of the driver, the interactive information IMG may selectively present a function list FL, an application program window EPW, auxiliary information AINF (in the present embodiment, the application program window EPW and the auxiliary information AINF are indicated by a same icon, though the invention is not limited thereto) and a background program window BPW. The display panel DP is approximately divided into an upper edge region Re1, a main region Rm and a lower edge region Re2. The permanent function column PFC can be set to be displayed in the upper edge region Re1 of the interactive information IMG. The permanent function column PFC may include some basic information (for example, a time, a temperature inside the vehicle, an icon of the currently executed application program, etc.).

The main region Rm can be used to display the currently executed application program window EPW, the function list FL for listing application programs or data folders and other auxiliary information AINF related to the driving information DINF or the environment information EINF. In the present embodiment, a window position and a window size of the currently executed application program window EPW and the auxiliary information AINF in the main region Rm can be adjusted by the driver through the operation motion. In other words, from a system point of view, the processing unit 140 may generate the corresponding display signal VDATA according to the operation motion of the driver, so as to make the transparent display 110 to adjust the window position and the window size of the currently executed application program on the display panel DP. For example, the driver may perform an operation motion to maximize the application program window EPW to occupy the full main region Rm, to set the application program window EPW to a center position, or minimize the application program window EPW to the background program window BPW.

The background program window BPW can be set to be displayed in the lower edge region Re2 of the interactive information IMG. In the present embodiment, the application program set to the background program is continually kept in a running state. Taking an application program of a navigation map shown in FIG. 4 as an example, the navigation map can be shrunk to a minor background program window BPW, and the GPS navigation function is continually executed. In other words, from the system point of view, when the driver performs a specific operation motion to implement a minimization operation, the motion detection unit 120 may generate a minimization command according to the operation motion of the driver, and the processing unit 140 shrinks the running application program to the lower edge region Re2 of the display panel DP according to the received minimization command, and continually executes the application program as the background program.

Moreover, in an application of the embodiment, the system may operate based on a method similar to a simplex operation, such that only a single application program window EPW can be displayed in the main region Rm at a same time. Namely, in case that one application program is executed, another application program cannot be executed. However, in the application example of the simplex operation, if the currently executed application program is minimized to the background program, another application program can be opened in the main region Rm. A plurality of the background program windows BPW can be displayed in the lower edge region Re2 at a same time. In other words, when the application program is executed and is not set to the background program, the processing unit 140 may prohibit execution of another application program. Conversely, when the currently executed application program is set to the background program, the processing unit 140 allows another application program to be executed. However, the invention is not limited thereto. In another application of the embodiment, the system may also operate based on a method similar to a multiplex operation, such that the processing unit 140 may simultaneously open a plurality of application programs, and display the application program window EPW of each application program in the main region Rm at a same time.

It should be noted that each of display portions (the permanent function column PFC, the function list FL, the application program window EPW, the auxiliary information AINF and the background program window BPW) in the interactive information IMG is presented in a display manner of a transparent window or a linear icon. Therefore, when the driver views the interactive information IMG on the display panel DP, the driver may simultaneously view the scenes and objects located at another side of the display panel without being shielded by the windows or the function list on the interactive information IMG.

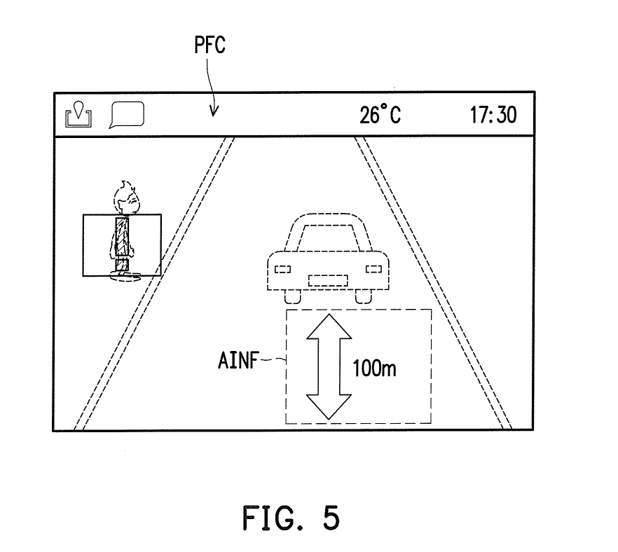

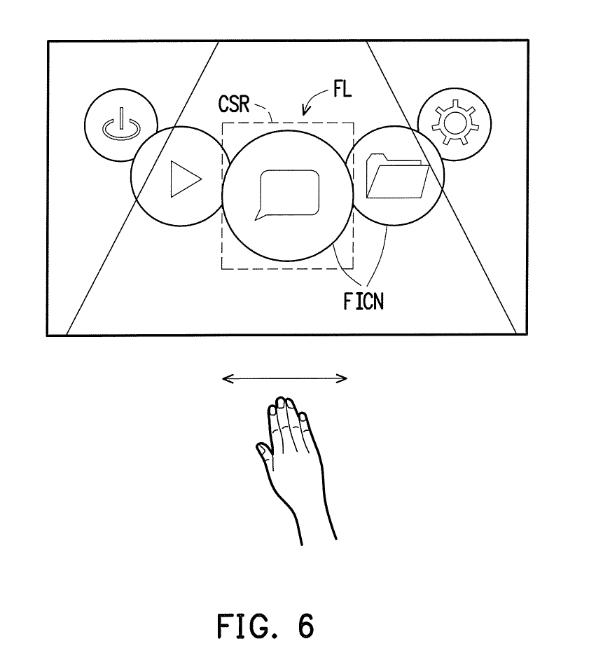

FIG. 5 is a schematic diagram of a driving perspective of a transportation vehicle applying the augmented reality interactive system according to an embodiment of the invention. Referring to FIG. 5, in the present embodiment, the augmented reality interactive system 100, for example, executes a safety warning application program. Under the function of the above application program, the function of the vehicle dynamic detection unit 130 can be applied to detect a distance between this vehicle and a front vehicle, and the distance is taken as the auxiliary information AINF for displaying on the display panel DP/windshield. Moreover, the application program may further detect a position of a pedestrian on the front road, and present a warning icon according to the position of the pedestrian, so as to remind the driver to pay attention to the pedestrian.

Under such application, the driver may obtain more complete driving information based on the augmented reality image composed of the information displayed on the display panel DP/windshield and the scenes and objects in the front under a premise of not obstructing a driving field of vision, so as to improve driving safety.

It should be noted that the above example is only an exemplary embodiment applying the augmented reality interactive system 100 of the invention, and the invention is not limited thereto. Actually, the function provided by the application program can be self expended and developed under the system structure of the invention according to a requirement of the designer. For example, in another embodiment, the application program can also be a basic GPS navigation map or an application program providing a visual enhancement function in the night.

Moreover, since the present application directly uses the display panel DP to serve as the windshield, the image can be displayed at any position of the display panel DP. In other words, under the system structure of the present application, by correspondingly adjusting the image displayed on the windshield in collaboration with the scenes and objects in the front of the transportation vehicle to achieve a more closely integrated augmented reality application is more easier to be implemented compared with the general projection type head-up display (HUD) system.

Embodiments of FIG. 6 to FIG. 9 are used to further describe the interactive operation portion of the invention. In the following embodiments, gesture motions are used to control the display of the interactive information IMG. Four different gestures are provided below for corresponding to four different functional operations, which are respectively open, shift, click and close. By referring to the following descriptions, those skilled in the art should understand that the designer can set different gesture motions for corresponding to different control commands CMD, so that the types of the control commands CMD are not limited to the following four types.

Referring to FIG. 1 and FIG. 6, which illustrate a situation that an open gesture is used to open the function list FL in the interactive information IMG. In the present embodiment, the predetermined open gesture of the motion detection unit 120 is a left right waving gesture. When the driver waves the hand around within a detection range of the motion detection unit 120, the motion detection unit 120 determines that the gesture of the driver is complied with the predetermined open gesture, and accordingly generates an open command. After the processing unit 140 receives the open command, the processing unit 140 opens the function list FL according to the open command. The function list FL includes a plurality of function option icons FICN, and each function option icon FICN corresponds to a different application program or a data folder. Moreover, a dash line frame in the interactive information IMG is a currently selected region CSR, and the function option icon FICN located in the currently selected region CSR represents the currently selected function option icon FICN.

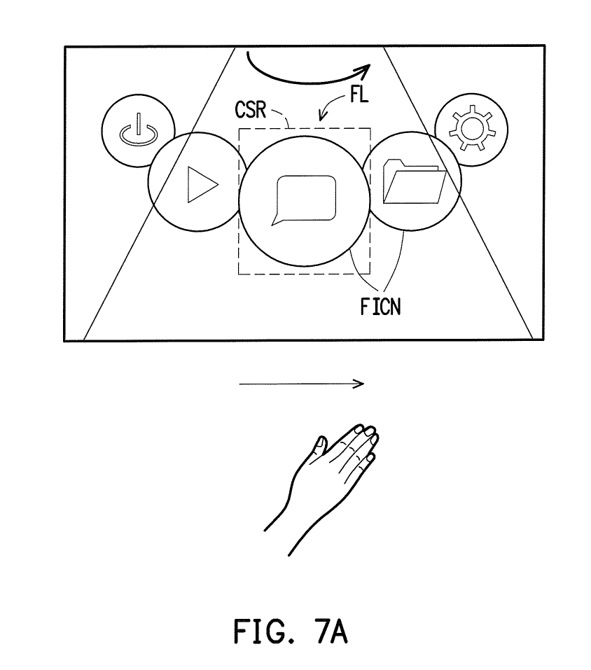

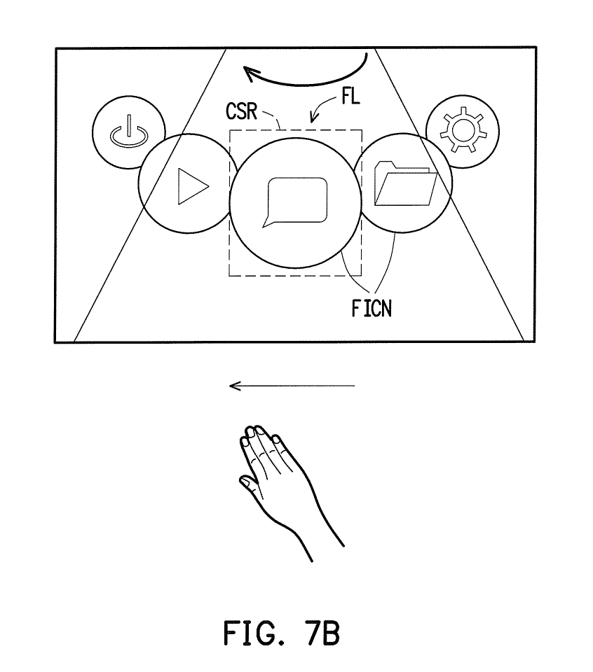

After the interactive information IMG displays the function list FL, the driver can further move the function option icons FICN in the function list FL through a shift gesture, as shown in FIG. 7A and FIG. 7B. In the present embodiment, a predetermined right shift gesture of the motion detection unit 120 is a gesture of shifting/waving the palm rightwards, and a predetermined left shift gesture is a gesture of shifting/waving the palm leftwards.

Referring to FIG. 7A and FIG. 7B, when the driver waves the hand leftwards or rightwards within the detection range of the motion detection unit 120, the motion detection unit 120 determines that the gesture of the driver is complied with the predetermined left shift gesture or the right shift gesture, and accordingly generates a left shift command or a right shift command. When the processing unit 140 receives the left shift command, the processing unit 140 shifts a display position of the function option icons FICN on the display panel DP leftwards by one step according to the left shift command. For example, the function option icon FICN located in the currently selected region CSR is shifted to a left side of the currently selected region CSR, and the function option icon FICN originally located at a right side of the currently selected region CSR is shifted to the currently selected region CSR.

Similarly, when the processing unit 140 receives the right shift command, the processing unit 140 shifts the display position of the function option icons FICN on the display panel DP rightwards by one step according to the right shift command. For example, the function option icon FICN located in the currently selected region CSR is shifted to the right side of the currently selected region CSR, and the function option icon FICN originally located at the left side of the currently selected region CSR is shifted to the currently selected region CSR.

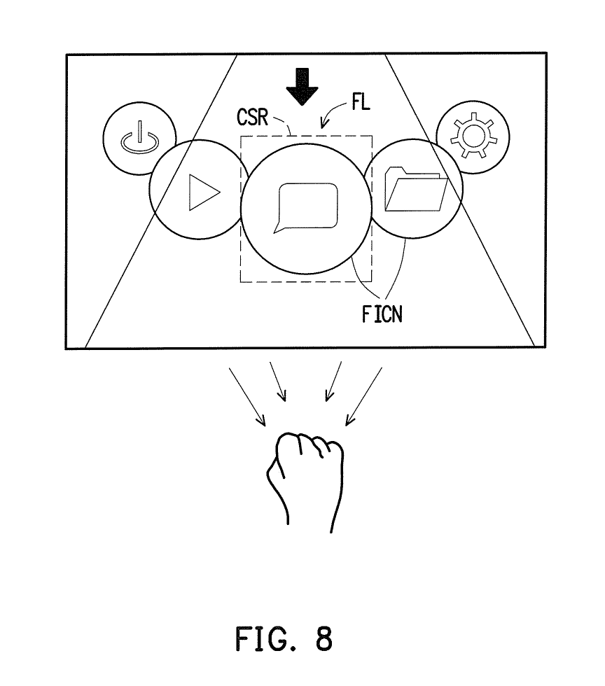

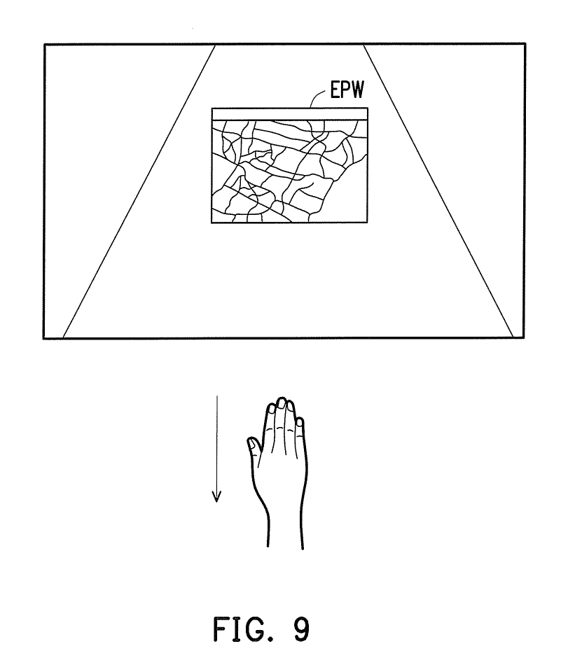

After the application program to be executed is selected, the driver may further select to execute the application program or the data folder corresponding to the function option icon FICN through a click gesture, as shown in FIG. 8. In the present embodiment, the predetermined click gesture of the motion detection unit 120 is a first clenching gesture.

Referring to FIG. 8, when the driver clenches a spread hand into a first within the detection range of the motion detection unit 120, the motion detection unit 120 determines that the gesture of the driver is complied with the click gesture, and accordingly generates a click command. When the processing unit 140 receives the click command, the processing unit 140 executes the application program or the data folder corresponding to the function option icon FICN located in the currently selected region CSR.

It should be noted that the gesture applications of the aforementioned embodiments are only examples, which are not used to limit the application range of the invention. In other embodiments, a gesture setting of the open gesture, the shift gesture, the click gesture, etc. of the invention can all be self-defined as any gesture motion according to an actual requirement of the designer, which is not limited by the invention.

After the driver completes using the function of the application program and wants to close the application program, the driver may further execute the application program or the data folder corresponding to the function option icon FICN through a close gesture, as shown in FIG. 9. In the present embodiment, the predetermined close gesture of the motion detection unit 120 is a gesture of moving down the palm.

Referring to FIG. 9, when the driver waves the hand downwards within the detection range of the motion detection unit 120, the motion detection unit 120 determines that the gesture of the driver is complied with the predetermined close gesture, and accordingly generates a close command. When the processing unit 140 receives the close command, the processing unit 140 closes the application program window EPW of the currently executed application program or the data folder according to the close command.

It should be noted that the close gesture/close command of the invention is not limited to the above application. In an exemplary embodiment, the processing unit 140 may close all of the running background programs according to the close command, so as to release a memory space. In other words, in the invention, the processing unit 140 may close the currently executed application program or data folder or close all of the background programs according to the close command.

In summary, the embodiments of the invention provides an augmented reality interactive system and a dynamic information interactive display method thereof, by which the interactive information can be displayed on the windshield, and the interactive information can be integrated with scenes and objects in front of the transportation vehicle to form an augmented reality image under a premise of not shielding a sight line of the driver. In collaboration with extensible application programs, the driver is able to perform an interactive operation with the augmented reality image, so as to obtain more complete driving information and driving assistance to improve driving safety and operability.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

1. An augmented reality interactive system, adapted to be disposed in a transportation vehicle, the augmented reality interactive system comprising:
a transparent display, having a display panel pervious to light, the display panel being adapted to serve as a windshield of the transportation vehicle, wherein the transparent display controls an image displayed on the display panel according to a display signal, so as to display interactive information associated with driving information and environment information of the transportation vehicle on the display panel;
motion detection unit, configured to detect an operation motion of an user performed within a detection range, so as to generate a control command corresponding to the operation motion, wherein the operation motion is one of a plurality of gesture motions without contacting the motion detection unit, each of the gesture motions corresponds to a different control command on the interactive information, and wherein the motion detection unit comprises an image capturing device; and
a processing unit, coupled to the transparent display and the motion detection unit, and configured to receive the control command, so as to generate the corresponding display signal based on the operation motion for controlling an operation of the transparent display.

2. The augmented reality interactive system as claimed in claim 1, further comprising:
a vehicle dynamic detection unit, coupled to the processing unit, and configured to detect the driving information of the transportation vehicle and the environment information around the transportation vehicle, wherein the processing unit controls the image displayed on the display panel according to the driving information and the environment information.

3. The augmented reality interactive system as claimed in claim 1, wherein the control command comprises at least one of an open command, a shift command, a click command and a close command.

4. The augmented reality interactive system as claimed in claim 3, wherein the processing unit opens a function list according to the open command, the function list comprises a plurality of function option icons, and the function option icons respectively correspond to different application programs or data folders.

5. The augmented reality interactive system as claimed in claim 4, wherein the processing unit shifts a display position of the function option icons on the display panel according to the shift command.

6. The augmented reality interactive system as claimed in claim 4, wherein the processing unit executes the application program or the data folder corresponding to the function option icon located in a currently selected region of the display panel according to the click command.

7. The augmented reality interactive system as claimed in claim 4, wherein the processing unit closes the currently executed application program or the data folder or closes all of background programs according to the close command.

8. The augmented reality interactive system as claimed in claim 4, wherein the processing unit adjusts a widow position and a window size of the currently executed application program on the display panel according to the operation motion.

9. The augmented reality interactive system as claimed in claim 4, wherein the processing unit shrinks a window of the currently executed application program to an edge of the display panel according to a minimization command, and continually executes the same as a background program.

10. The augmented reality interactive system as claimed in claim 9, wherein when an application program is executed and is not set as the background program, the processing unit prohibits execution of another application program, and when the currently executed application program is set as the background program, the processing unit allows execution of the another application program.

11. A dynamic information interactive display method applied to a transportation vehicle, comprising:
displaying interactive information associated with driving information and environment information of the transportation vehicle through a display panel pervious to light, wherein the display panel is adapted to serve as a windshield of the transportation vehicle, and an image displayed on the display panel is controlled by a display signal;
detecting an operation motion of an user performed within a detection range through a motion detection unit, so as to generate a control command corresponding to the operation motion, wherein the operation motion is one of a plurality of gesture motions without contacting the motion detection unit, each of the gesture motions corresponds to a different control command on the interactive information, and wherein the motion detection unit comprises an image capturing device; and
receiving the control command through a processing unit, so as to generate the corresponding display signal based on the operation motion for controlling the display panel.

12. The dynamic information interactive display method applied to the transportation vehicle as claimed in claim 11, wherein the step of detecting the operation motion of the user through the motion detection unit, so as to generate the control command comprises:
detecting the gesture motion of the user;
determining whether the operation motion is complied with at least one of an open motion, a shift motion, a click motion and a close motion;
generating an open command when the motion detection unit determines that the detected operation motion is complied with the open motion;
generating a shift command when the motion detection unit determines that the detected operation motion is complied with the shift motion;
generating a click command when the motion detection unit determines that the detected operation motion is complied with the click motion; and
generating a close command when the motion detection unit determines that the detected operation motion is complied with the close motion.

13. The dynamic information interactive display method applied to the transportation vehicle as claimed in claim 12, wherein the step of receiving the control command through the processing unit, so as to generate the corresponding display signal based on the operation motion for controlling the display panel comprises:
opening a function list and displaying the function list on the display panel by the processing unit when the processing unit receives the open command, wherein the function list comprises a plurality of function option icons, and the function option icons respectively correspond to different application programs or data folders;
shifting a display position of the function option icons on the display panel by the processing unit when the processing unit receives the shift command;
executing the application program or the data folder corresponding to the function option icon located in a currently selected region of the display panel by the processing unit when the processing unit receives the click command; and
closing the currently executed application program or the data folder or closing all of background programs by the processing unit when the processing unit receives the close command.

14. The dynamic information interactive display method applied to the transportation vehicle as claimed in claim 13, wherein the step of receiving the control command through the processing unit, so as to generate the corresponding display signal based on the operation motion for controlling the display panel comprises:
shrinking a window of the currently executed application program to an edge of the display panel by the processing unit when the processing unit receives a minimization command, and continually executing the same as a background program.

15. The dynamic information interactive display method applied to the transportation vehicle as claimed in claim 14, wherein the step of receiving the control command through the processing unit, so as to generate the corresponding display signal based on the operation motion for controlling the display panel comprises:
prohibiting execution of another application program by the processing unit when an application program is executed and is not set as the background program; and
allowing execution of the another application program by the processing unit when the currently executed application program is set as the background program.

16. An augmented reality interactive system, adapted to be disposed in a transportation vehicle, the augmented reality interactive system comprising:
a transparent substrate, pervious to light and having a display function, wherein the transparent substrate is adapted to serve as a windshield of the transportation vehicle;
a motion detection unit, configured to detect an operation motion performed within a detection range, so as to generate a control command corresponding to the operation motion, wherein the operation motion is one of a plurality of gesture motions without contacting the motion detection unit, each of the gesture motions corresponds to a different control command on interactive information associated with driving information and environment information of the transportation vehicle, and wherein the motion detection unit comprises an image capturing device; and
a processing unit, coupled to the transparent substrate and the motion detection unit, and configured to receive the control command, so as to control an operation of the transparent substrate based on the operation motion.

17. The augmented reality interactive system as claimed in claim 1, wherein the operation motion further comprises an eye control motion.

18. The augmented reality interactive system as claimed in claim 1, wherein the operation motion further comprises a brain wave control motion, and wherein the motion detection unit further comprises a brain wave detection device.

19. The augmented reality interactive system as claimed in claim 1, wherein the interactive information comprises a permanent function column displaying basic information, a window displaying the driving information and the environment information of the transportation, and a background program window displaying at least one background program.
